(19) United States
(12) Patent Application Publication
(10) Pub. No.: US 2020/0153544 A1
(43) Pub. Date: May 14, 2020

(54) DECODING METHOD OF SOFTWARE MODEM IN LIMITED MEMORY ENVIRONMENT USING OVERLAPPING FRAGMENTATION AND PROGRESSIVE DECODING

(71) Applicants: Airport Co., Ltd., Daejeon (KR); Korean Advanced Institute of Science and Technology, Daejeon (KR); Hanbat National University Industry-Academic Cooperation Foundation, Daejeon (KR)

(72) Inventors: Sung-Jun Baik, Daejeon (KR); Yung Yi, Daejeon (KR); Jin Hwan Jung, Gyeonggi-do (KR); Joon Ki Hong, Gyeonggi-do (KR); June Ha Song, Seoul (KR); Joo Hyun Kang, Gangwon-do (KR); Eui Rim Jeong, Daejeon (KR); Gun Ho Lee, Daejeon (KR); So Young Ju, Daejeon (KR)

(21) Appl. No.: 16/670,700

(22) Filed: Oct. 31, 2019

(30) Foreign Application Priority Data
Nov. 9, 2018 (KR) 10-2018-0137438

(51) Int. Cl. H04L 1/00; H04L 29/06

(52) U.S. Cl. CPC H04L 1/0054; H04L 69/166; H04L 1/0091; H04L 1/0059; H04L 1/0083; H04L 69/22

(57) ABSTRACT

The present invention relates to a decoding method of a software modem in a limited memory environment using overlapping fragmentation and progressive decoding, which processes packets in real-time and reduces power consumption in an environment in which memory is limited when the software modem is used, and the decoding method includes: (a) receiving a data packet from the signal processing device, by the software modem; (b) fragmenting the data packet, decoding the fragments by the fragment, and transferring a decoded MAC header to the MAC module, by the software modem; (c) analyzing the MAC header and verifying whether the packet is a data packet transmitted to the MAC module itself or the packet is damaged, by the MAC module; (d) directing, when the data packet is verified, the software modem to perform additional decoding on the data packet, by the MAC module; and (e) directing, when the data packet is not verified, the software modem to drop the data packet, by the MAC module.

According to the method as described above, since decoding is performed after receiving only some blocks of a packet, there is an effect of implementing the software modem in an MCU of a low price and a low specification even in a limited memory environment.

The present patent application was conducted with the support of Civil-Military Technology Cooperation Project UM17302RD3('17.6.21), “Development of ultra-low power long distance communication radio chip for IoT and remote monitoring device”.

### Research Project Related to the Invention

Project Identification Number: 17-CM-MC-10

Government Department: Defense Acquisition Program Administration

Specialized Organizations for Research Management Institute of Civil-Military Technology Cooperation, Agency for Defense Development

Research Project Name: Civil-Military Combined Technology Development Project

Research Item Name: Development of ultra-low power long distance communication radio chip for IoT and remote monitoring device

Main Organization: AIRPOINT CO., LTD.

Research Period: Jun. 21, 2017-Jun 20, 2020

### BACKGROUND OF THE INVENTION

### Field of the Invention

The present invention relates to a decoding method of a software modem in a limited memory environment using overlapping fragmentation and progressive decoding, which processes packets in real-time and reduces power consumption in an environment in which memory is limited when the software modem is used.

### Background of the Related Art

Generally, in a software modem, a microcontroller

(Micro Controller Unit, MCU) of a computer device processes various functions of the modem. The software modem is advantageous in that a modem more flexible and effective than a hardware modem can be designed.

In the case of a hardware modem, basic parameters are fixed. However, there is a loss in time and cost to change the fixed values. Contrarily, the software modem is able to change the basic parameters by simply changing a code.

However, in the case of the software modem, much memory of the microcontroller (MCU) is consumed to perform various signal processing. Accordingly, a microcontroller (MCU) of a high specification should be used to use memory of good performance. However, the microcontroller (MCU) of a high specification consumes much power, and its price is very high. When a microcontroller (MCU) product is selected, power consumption of the MCU or price competition with other companies should be considered. Accordingly, a user may not thoughtlessly use a microcontroller (MCU) of a high specification.

Accordingly, it needs to find a way of selecting a microcontroller (MCU) of low price and low specification and utilizing limited memory while minimizing power consumption.

### SUMMARY OF THE INVENTION

Accordingly, the present invention has been made in view of the above-mentioned problems occurring in the prior art, and it is an object of the present invention to provide a decoding method of a software modem in a limited memory environment using overlapping fragmentation and progressive decoding, which processes packets with a low delay and reduces power consumption in the limited memory environment through the cooperation of the modem and the Media Access Control (MAC) by configuring the parts of the modem and the Media Access Control (MAC) in an integrated structure, not a separated structure.

The modem performs decoding in real-time. First, the length of the MAC header is determined as the length of decoding. When the MAC header is decoded by the modem, the MAC confirms whether the packet is damaged or whether the packet is a packet of its own, determines whether or not to progress decoding by the modem, and informs a result of the determination. If it is determined that the packet is not damaged and the packet is a packet of its own, the modem continues additional decoding. In the opposite case, the modem stops decoding.

Therefore, the signal processing process in the modem can be drastically reduced, and power consumption can be reduced. That is, power consumption can be reduced by integrating the structures of the modem and the MAC and performing progressive decoding by the MAC through overlapping fragmentation modem processing, which can perform signal processing with limited memory of the MCU.

To accomplish the above objects, according to an aspect of the present invention, there is provided a decoding method of a software modem in a limited memory environment using overlapping fragmentation and progressive decoding, which is performed by a signal processing device, the software modem implemented in a microcontroller (MCU), and a MAC module, the method comprising the steps of: (a) receiving a data packet from the signal processing device, by the software modem; (b) fragmenting the data packet, decoding the fragmented data packets respectively, and transferring a decoded MAC header to the MAC module, by the software modem; (c) analyzing the MAC header and verifying whether the packet is a data packet transmitted to the MAC module itself or the packet is damaged, by the MAC module; (d) directing, when the data packet is verified, the software modem to perform additional decoding on the data packet, by the MAC module; and (e) directing, when the data packet is not verified, the software modem to drop the data packet, by the MAC module.

In addition, there is provided a decoding method of a software modem in a limited memory environment using overlapping fragmentation and progressive decoding, which is performed by a signal processing device of hardware, the software modem implemented in a microcontroller (MCU), and a MAC module, the method comprising the steps of: (a) receiving a data packet from the signal processing device, by the software modem; (b) fragmenting the data packet, decoding the fragmented data packets respectively, and transferring a decoded MAC header to the MAC module, by the software modem; (c1) determining whether the MAC header is in a broadcast mode, by the MAC module; (c2) confirming, when the MAC header is not in the broadcast mode, whether a destination address of the MAC header is an address of its own; (c3) confirming, when the MAC header is in the broadcast mode or in a unicast mode and the destination address is an address of its own, a packet type, and determining whether the packet type matches status of a receiving end point; (c4) determining, when the packet type matches the status of the receiving end point, whether the packet is a packet having information of an effective length; (d) decoding, when the packet is a packet having information of an effective length, a packet frame following the MAC header; and (e) dropping the data packet under progress when the destination address is not the address of its own at step (c2), the packet type does not match the status of the receiving end point at step (c3), or the packet is not a packet having information of an effective length at step (c4).

In addition, in the decoding method of the software modem in a limited memory environment using overlapping fragmentation and progressive decoding, the decoding is decoding for error correction of the data packet, and the software modem decodes using Viterbi decoder.

In addition, in the decoding method of the software modem in a limited memory environment using overlapping fragmentation and progressive decoding, a fragmentation unit of the fragments is an encoding size corresponding to the MAC header.

In addition, in the decoding method of the software modem in a limited memory environment using overlapping fragmentation and progressive decoding, the software modem decodes using a decoder, wherein the decoder decodes the fragments fragmented in same size at all times.

In addition, in the decoding method of the software modem in a limited memory environment using overlapping fragmentation and progressive decoding, although the fragmentation unit of the fragments is determined as the encoding size of the MAC header, the length of the fragment is set to be longer than the encoding size of the MAC header by predetermined size (overlapping size).

In addition, in the decoding method of the software modem in a limited memory environment using overlapping fragmentation and progressive decoding, a convolution code is used as an error correction code, and a Viterbi decoder is used as the decoder.

In addition, the present invention relates to a computer-readable recording medium recording a program which performs the decoding method described above.

In addition, the present invention decodes the error correction code in a packet frame by applying an overlapping fragmentation method and a progressive decoding method.

In addition, preferably, the present invention applies a convolution code (particularly, a Viterbi code) as the error correction code. The error correction code includes various types of code, such as a convolution code, a Viterbi code and the like, and may apply all of these codes. In the present invention, the convolution code is described (particularly, the Viterbi code) as a preferred embodiment.

The present invention includes a Viterbi decoder, which is a module performing reception decoding in a system using a convolution code as the correction code. The Viterbi decoder searches for a path through several paths by using a received data passing through a channel and then decodes data of a selected path while maintaining only a minimum distance path having high likelihood.

The Viterbi decoder of the present invention selects a path of high likelihood by using the received data.

Particularly, the Viterbi decoder of the present invention does not decode a whole packet after receiving the whole packet by using an overlapping fragmentation method, but divides an incoming signal to have a length matching the MAC header length and progressively performs decoding.

In addition, when decoding of the MAC header is completed, the software modem immediately transmits the header to the MAC. The MAC decodes several control data of the header part in the progressive decoding method and confirms whether the packet is damaged or whether the packet is a packet of its own.

The MAC determines whether or not to progress additional decoding for the incoming signal on the basis of a result confirmed by the software modem and transmits a result of the determination. The software modem receives the result and progresses additional decoding or stops decoding.

That is, a receiver modem restores the data and obtains MAC information. At this point, the MAC information is configured of a MAC header and a MAC data, and the MAC header includes a receiver address and the like. That is, rather than confirming the packet after restoring all the MAC information, the packet is confirmed after restoring only the MAC header.

Accordingly, the software modem may not perform unnecessary decoding and may reduce power consumption. In addition, since decoding of the next packet is immediately performed as the packet is discarded during the process, the processing speed can be enhanced. That is, since MAC data restoration may not be performed if the packet is not a packet for the MAC, efficiency such as power consumption reduction or the like of the receiver can be enhanced.

### BRIEF DESCRIPTION OF THE DRAWINGS

FIG. 1 is a view showing the configuration of the whole system for embodying the present invention.

FIG. 2 is a view showing the structure of a decoder according to prior art.

FIG. 3 is a view showing the structure of a decoder according to the present invention.

FIG. 4 is a view comparing a decoder according to a prior art and a decoder according to the present invention.

FIG. 5 is a view showing the structure of overlapping fragmentation according to an embodiment of the present invention.

FIG. 6 is a flowchart illustrating a decoding method of a software modem in a limited memory environment using overlapping fragmentation and progressive decoding according to an embodiment of the present invention.

### DETAILED DESCRIPTION OF THE PREFERRED EMBODIMENT

Hereinafter, detailed contents for embodying the present invention will be described with reference to the attached drawings.

In addition, in describing the present invention, like elements will be denoted by like symbols, and repeated description thereof will be omitted.

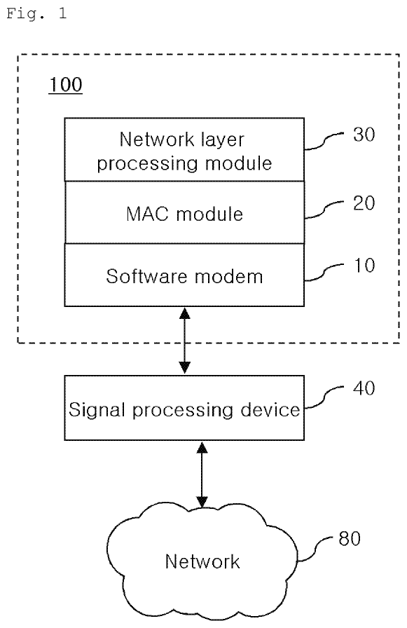

First, an example of a whole system configuration for embodying the present invention will be described with reference to FIG. 1.

As shown in FIG. 1, the whole system for embodying the present invention is configured of a signal processing device 40, a software modem 10, a MAC module 20, and a network layer processing module 30.

At this point, the software modem 10, the MAC module and the network layer processing module 30 are a program system and may be implemented by a microcontroller (MCU) 100. In addition, the signal processing device 40 is implemented as a hardware device performing communication. In addition, the MCU 100 and the signal processing device 40 may be implemented as an embedded system.

First, the signal processing device 40 is a hardware device for transmitting and receiving data signals through a network 80. The signal processing device 40 is a simple communication signal conversion device implemented as an ultra-low power (ULP) chip to receive a physical signal, convert the physical signal into a digital signal or convert oppositely, and transmit the converted signal.

Preferably, the signal processing device 40 transmits and receives data through a wireless network.

That is, the signal processing device 40 receives a physical data signal, converts the physical data signal into a digital signal of a bit string, and transfers the bit string to the software modem 10.

In addition, the signal processing device 40 receives a communication data of bit string from the software modem 10, creates a physical data signal according to the bit string, and transmits the physical data signal to the network 80.

Next, the software modem 10 is a program module performing the functions of a modem and decodes or encodes data packets of the physical layer. In addition, the software modem receives and decodes data packets as a receiver modem and encodes data packets as a transmitter modem. In the present invention, the functions as a receiver modem will be described mainly.

That is, the transmitter modem performs signal processing on the MAC frame (MAC header and MAC data) received from the MAC module 20 and transmits the MAC frame to the receiver modem. The receiver modem restores the MAC header and the MAC data through signal processing and transmits the MAC header and the MAC data to the MAC module 20. In the case of signal processing, the transmitter modem performs spreading and FEC encoding (error correction encoding). The receiver modem performs despreading and decoding (error correction decoding).

Data packets of the physical layer are decoded or encoded for error correction. At this point, decoding or encoding is performed using a convolution code or the like as an error correction code. Particularly, the software modem 10 applies a Viterbi decoder as a decoder performing decoding.

In addition, the software modem 10 extracts a MAC frame by decoding a bit string or a packet received from the signal processing device 40, and transfers the extracted MAC frame to the MAC module 20. The MAC frame is configured of a MAC header and a MAC data. The software modem 10 functions as a receiver modem when it performs this function.

Meanwhile, the software modem 10 fragments a data packet in a predetermined length and performs decoding. Since the modem uses a convolution code as an error correction code, the original contents may be restored by fragmenting and decoding the data packet.

At this point, at least the length of the MAC header is determined as the length of fragmentation. Preferably, overlapping fragmentation may be applied by additionally extending the fragment to be longer than the length of data to be decoded.

In addition, the software modem 10 decodes the MAC header part first and transfer the MAC header to the MAC module 20. The MAC module 20 analyzes the received MAC header and determines whether the packet is valid to receive. For example, the MAC module 20 compares the destination address of the MAC header and its own address to find out whether the addresses are the same, and determines whether the packet is a packet delivered to the MAC module 20. According to the result of the determination, the software modem 10 transfers whether or not to decode the MAC data (i.e., additional decoding) to the MAC module 20.

In addition, the software modem 10 receives whether or not to additionally decode from the MAC module 20, and additionally decodes the MAC data of the data packet or discards the data packet. That is, the software modem 10 decodes the MAC data of the data packet only when the MAC module 20 permits additional decoding after the MAC header is decoded first and transferred to the MAC module 20. When a discard command is received from the MAC module 20, the software modem 10 does not decode the MAC data of the data packet and does not decode the packet data any more.

Next, the MAC module 20 includes a function of interfacing with the software modem 10, a function of interfacing with the network layer processing module 30, a function of determining whether or not to process (adopt) a data packet by analyzing the MAC header of a MAC frame, and a function of processing the MAC frame.

Particularly, the MAC module 20 receives the decoded MAC header from the software modem 10 and verifies corresponding data packet about whether the packet is damaged, whether the packet is a packet of its own, or the like. In addition, the MAC module 20 transfers whether or not to additionally decode the data packet (or whether or not to decode the MAC frame) to the software modem 10 according to the result of the verification.

Specifically, the MAC module 20 progresses signal processing using the decoded MAC header. The MAC contains most important information in the header of the packet (or frame). The header is configured of control data such as a start of frame delimiter (SFD) bit string, a destination address, a source address, a length/type, a check sum (cyclic redundancy check, CRC), and the like. The MAC module 20 analyzes the MAC header and verifies whether the packet is damaged or whether the packet is a packet of its own.

Meanwhile, the software modem 10 performs decoding in real-time. First, the length of the MAC header is determined as the length of decoding. When the MAC header is decoded by the software modem 10, the MAC module 20 confirms whether the packet is damaged or whether the packet is a packet of its own, determines whether or not to progress decoding by the software modem 10, and informs a result of the determination. If it is determined that the packet is not damaged and the packet is a packet of its own, the software modem 10 continues additional decoding. In the opposite case, the software modem stops decoding.

That is, the software modem 10 progresses decoding on the whole MAC data, as well as the MAC header, as a receiver modem. The MAC module 20 determines whether or not the receiver modem will continue decoding using the MAC header decoded by the receiver modem and transfers a result of the determination to the software modem 10.

When the receiver modem restores data, the MAC header and the MAC data are restored in order. At this point, since the receiver modem may confirm whether the packet is a packet that the receiver modem should receive if the MAC header can be restored first, it does not need to restore the MAC data positioning next to the MAC header. That is, if the software modem 10 restores only the MAC header and sends up the MAC header to the MAC module 20, the MAC module 20 confirms the MAC header and informs the software modem 10 of whether or not to restore (expressed as decoding) the MAC data positioning next to the MAC header.

Next, the network layer processing module 30 processes network layer frames such as the IP frame or the like included in the payload of the MAC frame. Preferably, the network layer processing module 30 may process the tasks of the transport layer or the session layer, in addition to the task of the network layer.

Preferably, the network layer processing module 30 is a system program implemented in the MCU 100.

Particularly, when data packets are transmitted and received by the TCP/IP protocol, the network layer processing module 30 performs a decoding or encoding work on the IP frames. However, this is not limited to the TCP/IP protocol and may be applied to various communication network protocols.

Next, the error correction code processed by the MAC module 20 according to an embodiment of the present invention will be described in detail.

The incoming signal handling process of the software modem may include innumerable processes or a small number of processes. However, generally, decoding of the error correction code for error correction is performed last.

The error correction code is located throughout a data packet or a bit string. That is, the error correction code is located in both the MAC header and the MAC data (payload). First, error correction is performed as much as a length corresponding to the MAC header. After the error correction is performed, the software modem immediately transfers the MAC header to the MAC module 20. The MAC module 20 performs a work of inspecting and confirming information on the MAC header. Then, the MAC module 20 determines whether or not to restore the MAC data and transfer a result of the determination to the receiver modem 10.

When an error occurs in pack information due to the effect of channel noise of the packet, the error correction code performs a function of correcting the error and restoring to a normal packet. However, decoding of the error correction code consumes a lot of memory in the process of handling the incoming signal.

Accordingly, it is very important to improve decoding of the error correction code to implement the software modem in the limited memory of the MCU. That is, the method according to an embodiment of the present invention may reduce use of memory and obtain a result of reducing memory use, reducing power consumption, reducing delay time, and increasing processing speed through a cooperative structure of the MAC and the modem.

There are various kinds of error correction code, such as a convolutional code, a Viterbi code and the like, and all of theses codes can be applied. In the present invention, the convolution code (particularly, the Viterbi code) will be described as an example. That is, although some error correction codes may apply various decoding methods in the present invention, Viterbi decoding among them will be described as an example.

A block which performs reception decoding in a system using a convolution code as an error correction code is referred to as a Viterbi decoder. The Viterbi decoder searches for a path through several paths by using a received data passing through a channel and then decodes data of a selected path while maintaining only a minimum distance path having high likelihood.

The function of the Viterbi decoder is included in the software modem 10.

That is, the Viterbi decoding does not find a set of all possible code strings, but finds a most likely code string one step at a time. The Viterbi method compares the distance between the trellis routes incoming into each state at each moment with the received code string and removes a path that is unlikely to be a final path from consideration. When there are two paths entering a certain state, a path of a shorter distance to the received code string is referred to as a survivor path.

In the decoding process, the computation amount is reduced by remaining only the survival path and removing the other path for each state. In the process of finding a code bit string of the shortest distance from the received code bit string, unlikely paths are deleted while creating a set of candidates of a likely code path, and a final demodulation path is selected among a small number of survival paths.

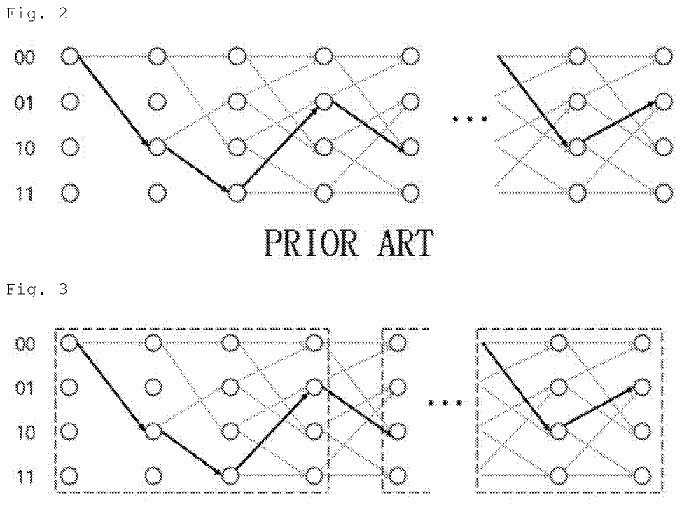

As shown in FIG. 2, the structure of a Viterbi decoder according to a conventional technique performs decoding on a received packet all at a time. From the aspect of memory, when decoding is performed for the entire length of the received packet, the length of the trellis route increases by the length of the packet. Operation of comparison and operation of path selection increase in proportion to increase of the trellis route. Accordingly, a considerable amount of memory is consumed.

However, the Viterbi decoding should be completed although the packet is damaged or wrongly delivered, and the packet is transmitted to the MAC module 20 thereafter. Accordingly, since the Viterbi decoding is conducted for the packets that do not need decoding, it can be regarded as a loss from the aspect of the overall system.

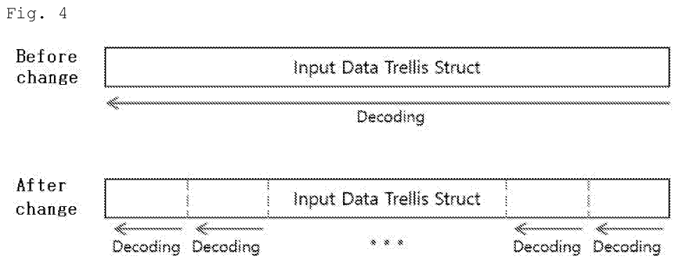

Contrarily, as shown in FIG. 3, the Viterbi decoder according to the present invention performs packet-decoding on the received packets in real-time by the block (or by the fragment). That is, the Viterbi decoding is performed in real-time. Particularly, the length of packet-decoding is determined in accordance to the length of the MAC header (the length corresponding to the MAC header, and the length corresponding to the MAC header may extended be longer than the length of the MAC header according to encoding method).

That is, the Viterbi decoder is designed to decode fragments of a predetermined length. Therefore, a whole data packet is divided into a plurality of fragments by the length, and the divided fragments are sequentially decoded. However, it is possible that the fragment of the MAC header part is decoded first, and fragments of the rear part may not be decoded according to direction of the MAC header 20.

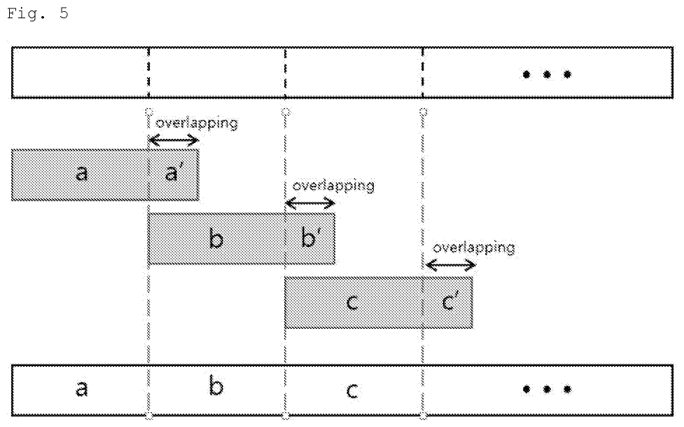

As shown in FIG. 4, the structure according to a conventional technique performs decoding on a whole received packet. However, the present invention performs decoding on the received packet using the length of the MAC header. Therefore, the method according to the present invention reduces the length of trellis for calculating an optimum path and reduces use of memory. Accordingly, the amount of memory used for the overall decoding can be reduced.

That is, since the method according to the present invention performs decoding by fragmenting a packet regardless of the extended length, compared with an existing method which uses memory as much as the extended data length, the efficiency of using the memory is enhanced. For example, when a packet of 160 bytes is received, the existing Viterbi decoder consumes 114,680 bytes of memory, whereas the Viterbi decoder according to the present invention consumes only 78,840 bytes of memory.

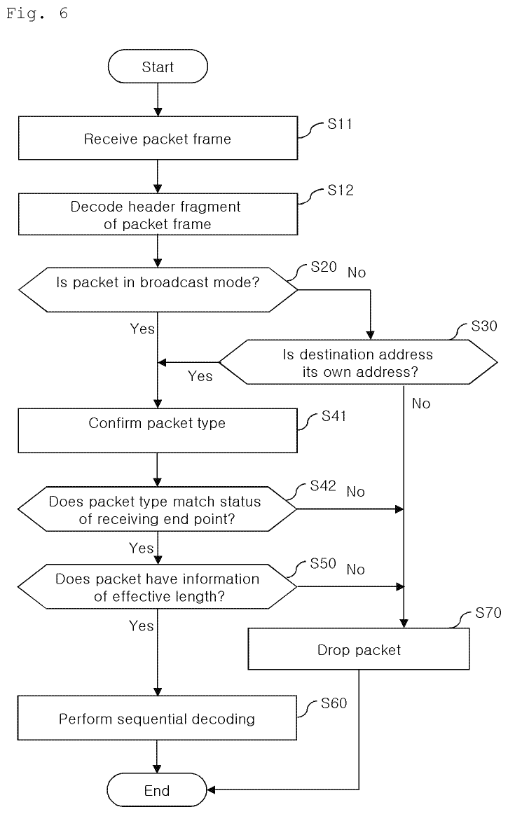

In addition, as shown in FIG. 5, the Viterbi decoder according to the present invention uses an overlapping fragmentation method to maintain the performance of the existing Viterbi decoder. The problem of degrading performance can be solved by using the overlapping fragmentation method for the Viterbi characteristic of having high reliability on the front side. The overlapping fragmentation method described above may obtain the profit of reducing power consumption and increasing the processing speed by integrating the modem and the MAC structures.

Error correction is a work conducted by a decoder. In the case of the decoder, error correction performance of the data on the front side is higher than the performance of the data on the rear side. Accordingly, error correction decoding is conducted by performing fragmentation in a length longer than the actual length of the MAC header. After decoding, data as much as the length of the MAC header on the front side is taken and transferred to the MAC module 20. The length of fragmentation is determined as much as a minimum length that does not sacrifice error correction performance at the MAC header.

The MAC determines the length of the header containing important information such as an address, a transmission method, a length, a type and the like. The length of the header may vary according to a situation. When the length of the header of the MAC is determined, the decoding length of the modem is determined. Packet 1 (MAC header) on which overlapping fragmentation is progressed is transferred to the MAC (or MAC module) in real-time. When the MAC module 20 reads the MAC header and determines that it is a packet that does not need to be read by a receiving end point, it request the software modem 10 to stop decoding to decrease power consumption and increase processing speed. That is, the progressive decoding method is progressed.

Next, a decoding method of a software modem in a limited memory environment using overlapping fragmentation and progressive decoding according to an embodiment of the present invention will described with reference to FIG. 6.

As shown in FIG. 6, first, the software modem 10 in the MCU 100 receives a packet frame or a data packet received through the signal processing device 40 (step S11).

Next, the software modem 10 performs decoding on the received packet frame or data packet by the fragment (step S12). That is, the software modem 10 receives a whole packet and decodes the packet after dividing the packet into fragments.

At this point, the data packet is divided into fragments by the length of encoding code (hereinafter, referred to as MAC header encoding length) corresponding to the MAC header. The encoding length (or size) of the MAC header may be longer than the length of the MAC header according to encoding method.

Preferably, although the fragment unit is determined as the encoding length of the MAC header, the length of the fragment may be set to be longer than the encoding length of the MAC header. That is, the fragment length is determined to be longer than the encoding length of the MAC header by predetermined length (overlapping length) so that a fragment is overlapped with another fragment.

In FIG. 5, a, b and c denote a fragmentation unit, and a′, b′ and c′ denote an overlapping part (overlapping size) of each fragment, respectively. Accordingly, although the fragmentation unit is a, b and c, the actual sizes of the fragment are a+a′, b+b′, and c+c′.

In addition, the software modem 10 decodes the fragments of the MAC header part first, extracts the MAC header, and transfer the MAC header to the MAC module 20.

Next, the MAC module 20 analyzes the MAC header decoded by the software modem 10 and confirms the transmission mode (step S20), and confirms whether the destination address is the address of its own when the transmission mode is not a broadcast mode (i.e., in the case of unicast mode) (step S30).

That is, information indicating unicast or broadcast is included in the MAC header. In the case of unicast mode, not the address of the receiving end point, the rear part of the MAC header does not need to be decoded. That is, when the address of the receiving end point, that is, the address of destination, is not the address of its own, the MAC module 20 drops the packet (step S70). That is, the MAC module 20 directs the software modem 10 to stop additional decoding on the data packet and discard the data packet.

In the case of broadcast mode or unicast mode destined to its own address, the MAC module 20 determines whether the packet type matches the current status of the receiving end point (step S41).

Next, if the packet type does not match the current status of the receiving end point (step S42), the MAC module 20 drops the packet (step S70). That is, this is possible since information on the packet type is included in the MAC header.

For example, if the packet type is ACK (response code), the receiving end point should be an end point that has not transmitted a packet to another end point. End points having other status do not need to read the ACK packet. That is, when the packet type is ACK, the software modem 10 confirms whether the end point has transmitted a packet to a corresponding end point, and if the end point has not transmitted a packet to the end point, decoding of the response code is stopped. That is, the packet is dropped.

When an end point has a packet to transmit and has transmitted a preamble, it becomes a receiving end point waiting for an ACK packet and waits for only the ACK packet. Accordingly, when an ACK packet is transmitted, the end points other than the end point that has transmitted a packet to another end point will not read and discard the ACK packet, and the end point that has transmitted the packet to another end point begins communication of exchanging data with the end point after receiving an ACK signal.

In addition, when an end point does not transmit or receive a packet and is in a status of progressing duty cycling, the work of decoding the rear part is meaningful only when the packet type is a preamble.

It is efficient from the aspect of power consumption that the end points in other status do not read the preamble packet and stop decoding. In addition, since unnecessary signal processing may not be performed, the decoding speed of the next packet increases.

It is most important for a low power wireless sensor to extend the lifetime by reducing energy consumption. Accordingly, the sensor does not to continuously turn on the radio in the status of not transmitting and receiving at normal times, but performs duty cycling of periodically turning on and off the radio.

When a certain end point performs duty cycling, it is a time in which any work for transmitting or receiving a packet is not conducted. When communication is required during the duty cycling (when it needs to receive or transmit a packet), it is difficult to immediately begin communication. Accordingly, an end point progressing duty cycling listens to only the preamble. The preamble is a signal which transfers information directing to prepare as communication will begin after the preamble.

When the preamble is received, the rear part should be decoded since it needs to figure out to which end point the preamble has been transferred. Like this, the preamble is meaningful only to an end point progressing duty cycling as usual without doing a transmitting or receiving work.

Next, the MAC module 20 determines whether the packet is a packet having information of an effective length (step S50). If the packet does not have information of an effective length, the software modem 10 drops the packet (step S70).

That is, information on the length of the payload is contained in the MAC header. The information on the length is compared to determine whether the length is actually equal to the total length of the remaining part of the packet. If they are not equal, it is a packet that does not contain information on the effective length, it is not read, and the decoding is stopped.

Next, when the MAC header has information of an effective length, the software modem 10 performs additional decoding on the packet frame (step S60).

That is, the software modem 10 decodes the MAC payload following the MAC header.

As described above, according to the decoding method of a software modem in a limited memory environment using overlapping fragmentation and progressive decoding of the present invention, since decoding is performed after receiving only some blocks of a packet, there is an effect of implementing the software modem in an MCU of a low price and a low specification even in a limited memory environment.

That is, when a receiver decodes an error correction code, it does not perform decoding after receiving a whole packet, but immediately performs decoding on a partial block as soon as receiving an incoming signal of a predetermined length shorter than the length of the whole packet. If the receiver performs decoding using an overlapping fragmentation method, the software modem can be implemented in an MCU of a low price and a low specification even in a limited memory environment.

In addition, if an incoming signal is decoded through fragmentation, it does not need to decode only after receiving a whole packet, but the receiver progressively receives and decodes the packet by the unit of fragmented block. If the MAC header is positioned in a block of the front end in the progressive decoding process like this, it is possible to decode the MAC header first and then determine whether or not to decode the incoming signal of the rear part.

The method like this is effective a) when the destination is not the receiving end point itself in the situation of unicast, b) when the packet is not a type to be received in the status of the receiving end point, c) when the total length of the remaining part is different from the length specified in the MAC header, or the like. That is, in these cases, it does not need to decode the remaining part other than the MAC header. Accordingly, an effect of saving memory and power used for decoding the rear part can be obtained.

Although the invention made by the inventor of the present invention has been described in detail according to the embodiments described above, the present invention is not limited thereto and may be diversely modified without departing from the gist of the present invention.

What is claimed is:

1. A decoding method of a software modem in a limited memory environment using overlapping fragmentation and progressive decoding, which is performed by a signal processing device, the software modem implemented in a microcontroller (MCU), and a MAC module, the method comprising the steps of:
(a) receiving a data packet from the signal processing device, by the software modem;
(b) fragmenting the data packet, decoding the fragmented data packets respectively, and transferring a decoded MAC header to the MAC module, by the software modem;
(c) analyzing the MAC header and verifying whether the packet is a data packet transmitted to the MAC module itself or the packet is damaged, by the MAC module;
(d) directing, when the data packet is verified, the software modem to perform additional decoding on the data packet, by the MAC module; and
(e) directing, when the data packet is not verified, the software modem to drop the data packet, by the MAC module.

2. The method according to claim 1, wherein the decoding is decoding for error correction of the data packet, and the software modem decodes using a decoder.

3. The method according to claim 1, wherein a fragmentation unit of the fragments is an encoding size corresponding to the MAC header.

4. The method according to claim 1, wherein the software modem decodes using a decoder, wherein the decoder decodes the fragments fragmented in same size at all times.

5. The method according to claim 4, wherein although the fragmentation unit of the fragments is determined as the encoding size of the MAC header, length of the fragment is set to be longer than the encoding size of the MAC header by predetermined size (overlapping size).

6. The method according to claim 3, wherein a convolution code is used as the error correction code, and a Viterbi decoder is used as the decoder.

7. A computer-readable recording medium recording a program performing the decoding method of claims 1.

8. A decoding method of a software modem in a limited memory environment using overlapping fragmentation and progressive decoding, which is performed by a signal processing device, the software modem implemented in a microcontroller (MCU), and a MAC module, the method comprising the steps of:
(a) receiving a data packet from the signal processing device, by the software modem;
(b) fragmenting the data packet, decoding the fragmented data packets respectively, and transferring a decoded MAC header to the MAC module, by the software modem;
(c1) determining whether the MAC header is in a broadcast mode, by the MAC module;
(c2) confirming, when the MAC header is not in the broadcast mode, whether a destination address of the MAC header is an address of its own;
(c3) confirming, when the MAC header is in the broadcast mode or in a unicast mode and the destination address is an address of its own, a packet type, and determining whether the packet type matches status of a receiving end point;
(c4) determining, when the packet type matches the status of the receiving end point, whether the packet is a packet having information of an effective length;
(d) decoding, when the packet is a packet having information of an effective length, a packet frame following the MAC header; and
(e) dropping the data packet under progress when the destination address is not the address of its own at step (c2), the packet type does not match the status of the receiving end point at step (c3), or the packet is not a packet having information of an effective length at step (c4).

9. The method according to claim 8, wherein the decoding is decoding for error correction of the data packet, and the software modem decodes using a decoder.

10. The method according to claim 8, wherein a fragmentation unit of the fragments is an encoding size corresponding to the MAC header.

11. The method according to claim 8, wherein the software modem decodes using a decoder, wherein
the decoder decodes the fragments fragmented in same size at all times.

12. The method according to claim 11, wherein although the fragmentation unit of the fragments is determined as the encoding size of the MAC header, length of the fragment is set to be longer than the encoding size of the MAC header by predetermined size (overlapping size).

13. The method according to claim 10, wherein a convolution code is used as the error correction code, and a Viterbi decoder is used as the decoder.

14. A computer-readable recording medium recording a program performing the decoding method of claims 8.
